(19) United States
(12) Patent Application Publication
(10) Pub. No.: US 2003/0179303 A1
(43) Pub. Date: Sep. 25, 2003

(54) Opto-digital zoom for an image capture device

(76) Inventor: Wilfried Bittner, New Territories (CN)

Correspondence Address: Kerry Sisselman, Concord Camera Corp., Suite 650N, 4000 Hollywood Blvd., Hollywood, FL, 33021, US

(21) Appl. No.: 10/393,094

(22) Filed: Mar. 20, 2003

Related U.S. Application Data
(60) Provisional application No. 60/366,296, filed on Mar. 20, 2002.

(51) Int. Cl. H04N 5/262

(52) U.S. Cl. 348/240.3

(57) ABSTRACT

An image capture device is provided which performs a combination of digital and optical zoom techniques to achieve high levels of zoom without sacrificing image quality. In a first embodiment, an opto-digital lens system is provided including a wide angle lens and a normal lens, the transition between which is smoothed using moderate digital zooming. Starting from the wide angle fixed optical length, the processor may be used to digitally zoom the captured image. At a predetermined point during the digital zoom operation, the normal lens is placed into the optical path and the processor again digitally zooms the beginning.

### PRIORITY

The present application claims priority from co-pending provisional patent application serial No. 60/366,296, Filed on Mar. 20, 2002 and entitled OPTO-DIGITAL ZOOM FOR AN IMAGE CAPTURE DEVICE.

### FIELD OF THE INVENTION

The present invention relates to the field of image capture devices, and more particularly, to a method and apparatus for increasing the zoom capability of an image capture device without requiring an actual optical zoom lens.

### BACKGROUND OF THE INVENTION

Image capture devices including optical zoom lenses are known. However optical zoom lenses tend to be expensive and difficult to manufacture.

Some digital cameras permit “digital zoom”, which effectively crops the captured image and digitally enlarges (up-samples) the image to create the visual effect of zooming in. However, one trade-off of digital zoom is reduced image quality.

Cameras are known which use both optical zoom and digital zoom. In such cameras the digital zoom function is arranged to start only from the telephoto end of an optical zoom system after the optical zoom has reached its maximum focal length.

There is a need for a method and apparatus to provide a digital camera with a low cost effective zoom, without having to sacrifice the quality of the image.

### SUMMARY OF THE INVENTION

An image capture device is provided which performs a combination of digital and optical zooming to achieve high levels of zoom without sacrificing image quality. In a first embodiment, the opto-digital lens system includes a wide angle lens and a normal lens the transition between which is smoothed using moderate digital zooming. Starting from the wide angle fixed optical length, the processor may be used to digitally zoom the captured image. At a predetermined point during the digital zoom operation, the normal lens is placed into the optical path and the processor may be used again to digitally zoom the captured image. As such, zooming is accomplished without an actual zoom lens and without the degradation that could occur at high powers of digital zoom.

Other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. In the drawings:

FIGS. 1A and 1B show an image capture device in accordance with one particular embodiment of the present invention.

FIG. 2 is a curve showing effective focal length vs. zoom position.

FIG. 3A is a chart showing digital zoom factor vs. zoom step in a step zoom system in accordance with one particular embodiment of the present invention.

FIG. 3B is a chart showing digital zoom factor vs. zoom position in a stepless zoom system in accordance with one particular embodiment of the present invention.

FIGS. 4A and 4B show an image capture device in accordance with another particular embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

The present invention provides a “virtual” zoom for an image capture device not including an optical zoom lens. Rather, the image capture device of the present invention includes a wide angle lens and a normal lens and some moderate digital zooming which will not unacceptably deteriorate the image quality. Starting from the wide angle fixed optical length the processor may be used to digitally zoom the captured image. At a predetermined point during the digital zoom operation, the normal lens is placed into the optical path and the digital zoom starts again from the beginning. As such, zooming is accomplished without an actual zoom lens and without the degradation that could occur at high powers of digital zoom. The phrases “digital zoom”, “digitally zoom” and “digitally zooming” as used herein refer to the known technique of effectively cropping the sensed image while digitally enlarging the image to create the visual effect of zooming in.

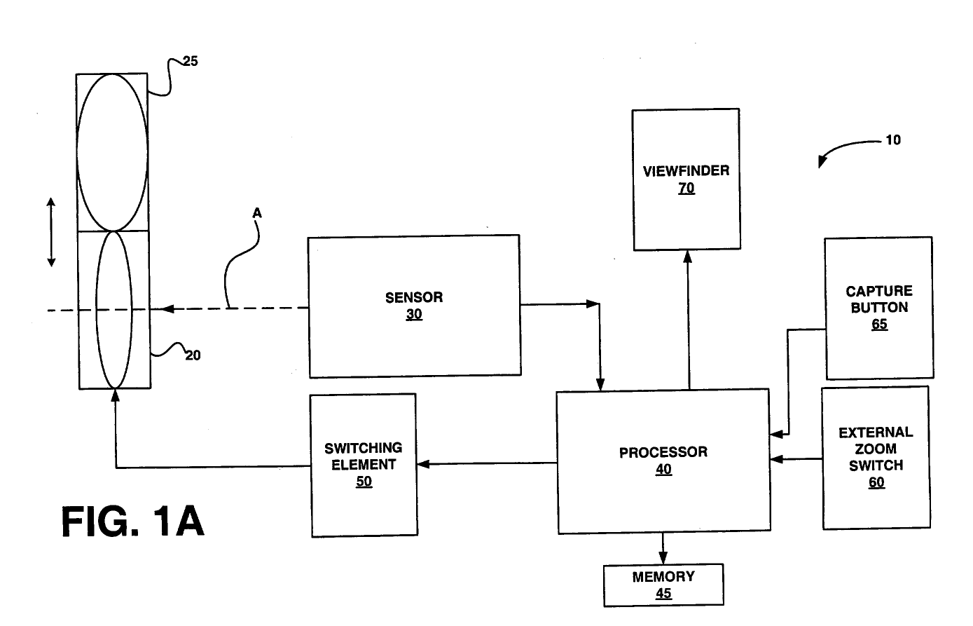

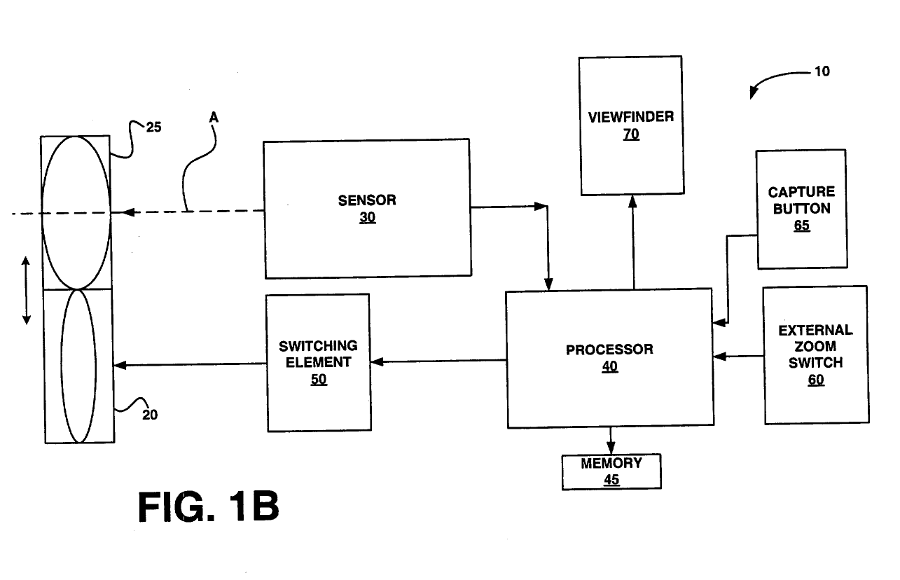

Referring now to FIGS. 1A and 1B, there is shown one embodiment of an image capture device 10 that could be used with the present invention. The image capture device 10 includes two lenses/groups, of which one is a wide angle lens 20 and one is a normal lens 25. An optical axis A is defined from an image sensor 30, which may be a solid state optical sensor, such as a CMOS or CCD sensor. For digital cameras the size of the lens is only a tiny portion of the volume of the entire camera. Having two lenses in one camera has practically no effect on the overall size. By using two separate taking lenses, or one basic lens with two different switchable groups, or one basic lens plus one converter lens group, the optical and mechanical structure of the camera becomes significantly simpler and cheaper than a traditional zoom lens.

In the present embodiment, the wide angle lens group 20 is initially placed on the optical axis A. The processor 40 controls the capture and processing of images. Additionally, the processor 40 controls the digital zoom operation when the user activates the external zoom switch 60, which is part of the user interface. At a predetermined point in the digital zoom process, the processor 40 causes a switching element 50 to switch the normal lens 25 into the optical axis A and restarts the digital zoom at 1× magnification. Switching element 50 may be a mechanical actuator or slide arm, a solenoid, a motor and gear train, or some other means of moving the lenses 20 and 25 onto the optical axis A.

For example, the two lenses 20 and 25 may be mounted linearly on a carriage having teeth at the base. A gear train may intersect the teeth at the base of the carriage such that when a motor rotates a motor shaft and gear in a first direction the carriage is moved such that the normal lens is driven onto the optical axis. When the motor is rotated in the opposite direction, the carriage is withdrawn such that the wide lens 20 returns to the optical axis A.

Alternately, the lenses may be mounted linearly on a carriage that is spring biased to maintain the wide angle lens 20 centered on the optical axis. The switching mechanism 50 may include a solenoid connected to the carriage to pull the carriage such that the normal lens 25 is centered on the optical axis A when the solenoid is powered. After zooming is completed and a picture is captured, the solenoid may be deactivated to release the spring biased carriage and return the wide angle lens 20 to its normal position centered on the optical axis A.

If the user continues to actuate the external zoom switch 60, the processor continues to digitally zoom the scene to be captured up to the maximum zoom amount attributable to the optical lens focal length of the normal lens and the digital zoom magnification factor. If desired, an additional lens or lens group, such as a telephoto lens (not shown), may be switched into the optical path after the processor 40 has reached the maximum digital zoom with the normal lens 25 in the optical axis A.

A viewfinder 70 may be provided to give the user an interface through which to frame the scene and observe the zooming of the image capture device. Viewfinder 70 may be an optical zoom viewfinder (i.e., real image, reversed Galilean zoom or variable mask) or an electronic viewfinder (i.e., LCD or microdisplay). If an electronic viewfinder is used, the processor 40 may cover the point at which the two lenses 20 and 25 are switched by freezing the image on the display until the lenses have changed, thus eliminating any visible dark phases in the process. If an optical viewfinder is used, the user only sees a smooth zooming action through the entire range of the zoom and may only hear the lens being switched.

To capture the scene, the user actuates an image capture button 65 and the processor 40 causes the opto-digitally enhanced scene to be stored in non-volatile memory 45.

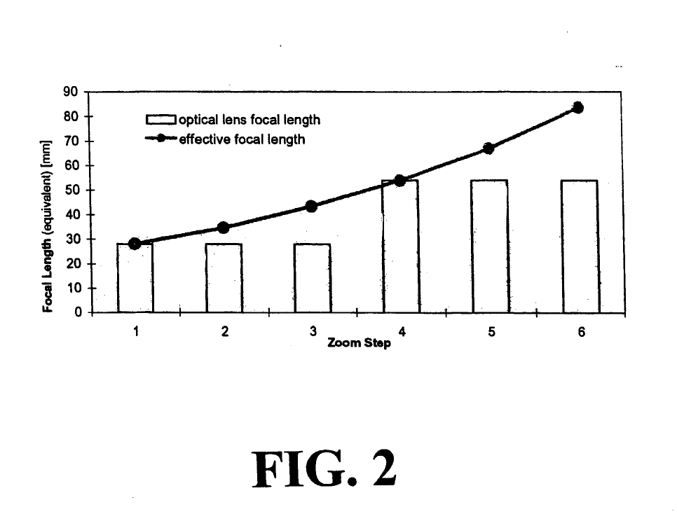

Referring now to FIG. 2, there is shown the effective zoom curve useful to illustrate an example of an image capture device of the present invention having a 3× magnification effective zoom, wherein 2× magnification is attributable to the optics and 1.5× magnification to the digital zoom. Table 1 below shows the optical focal length and effective focal length for each zoom position or step for the zoom curve of FIG. 2. Note that when focal length is described herein these focal lengths are equivalent focal lengths to a 35 mm film format.

TABLE 1

| | Optical Lens | Effective | Step Digital | Stepless | |
|---|---|---|---|---|---|
| | Focal | Focal | Zoom | Digital Zoom | |
| | Length | Length | Magnifcation | Magnification | |
| Zoom Step | (mm) | (mm) | Factor | Factor | Lens |
| 1 | 28 | 28 | 1 | 1 | Wide |
| 2 | 28 | 35 | 1.24 | 1.24 | Wide |
| 3 | 28 | 43 | 1.55 | 1.55 | Wide |
| 4 | 54 | 54 | 1 | 1.93/1 | Wide/Normal |
| 5 | 54 | 67 | 1.24 | 1.24 | Normal |
| 6 | 54 | 84 | 1.55 | 1.55 | Normal |

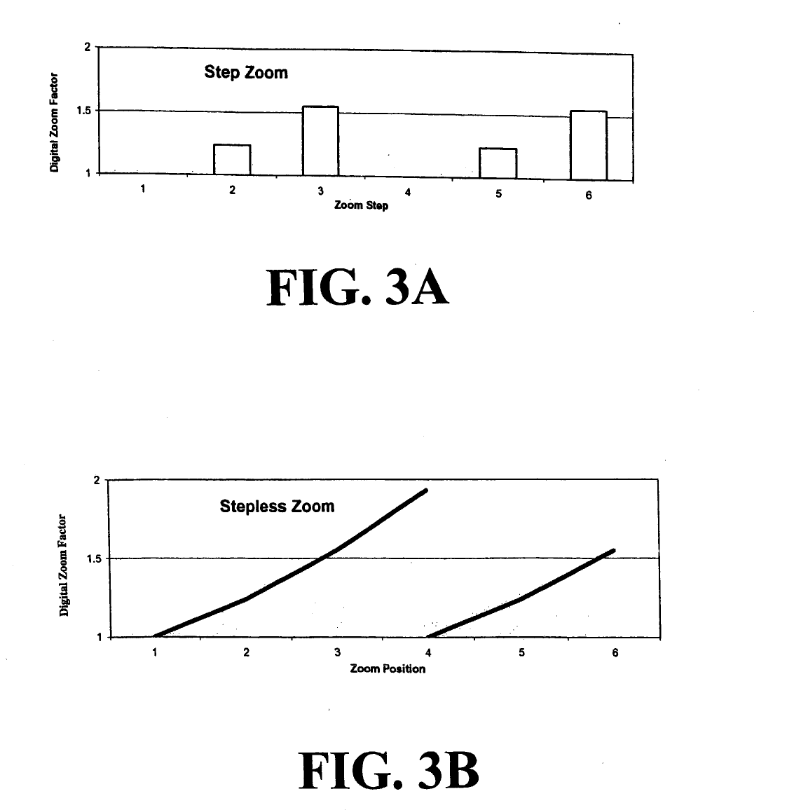

FIGS. 3A and 3B show the digital zoom factor versus zoom position or step for the example of FIG. 2 for the step zoom and stepless zoom, respectively.

As can be seen from TABLE 1 and FIGS. 1A-3B, in the example having a 3× effective zoom, the first (wide) lens having an optical focal length of 28 mm is disposed along the optical axis. The processor of the image capture device than digitally zooms the framed image up to about 1.55 times in a step zoom system or about 1.93 times in a continuous, stepless zoom system, depending on the particular implementation of the device. Note that this is not meant to be limiting. The present invention may be used in systems having larger effective zoom ranges, for example, using higher powers of digital zoom (i.e. 2× for an effective zoom of 4×).

At the maximum predetermined zoom power, the processor 40 switches the second (normal) lens 25 having an optical focal length of 54 mm into the optical axis, simultaneously removing the first (wide) lens 20. After switching to the second lens, the processor 40 again begins the digital zoom again at 1× power and proceeds up to about 1.55× to provide about a 3× effective zoom.

The present invention is preferably implemented using a step zoom system, although a stepless zoom may alternately be used. The advantages of a step zoom system for the invention include a lower requirement on the processor 40 if an electronic viewfinder 70 is employed and a lower maximum digital zoom ratio at the lens switching point (1.55× vs. 1.93×), which is advantageous to the image quality. Additionally, in a step zoom system it is easy to hide the switch-over phase of the optical lenses. The LCD image stays frozen until the next step has been reached, and during that time the lenses can move across the sensor.

The two lenses of the present invention can slide, flip or rotate into position. Preferably, the zoom action of the present invention is motorized and creates the same feel as a conventional zoom. However manual operation to switch the lenses is also possible. Additionally, the two lenses may be placed linearly on the optical axis A, and the switching mechanism (50 of FIG. 1) may cause one and/or the other lens to drop off of the optical axis A when not needed.

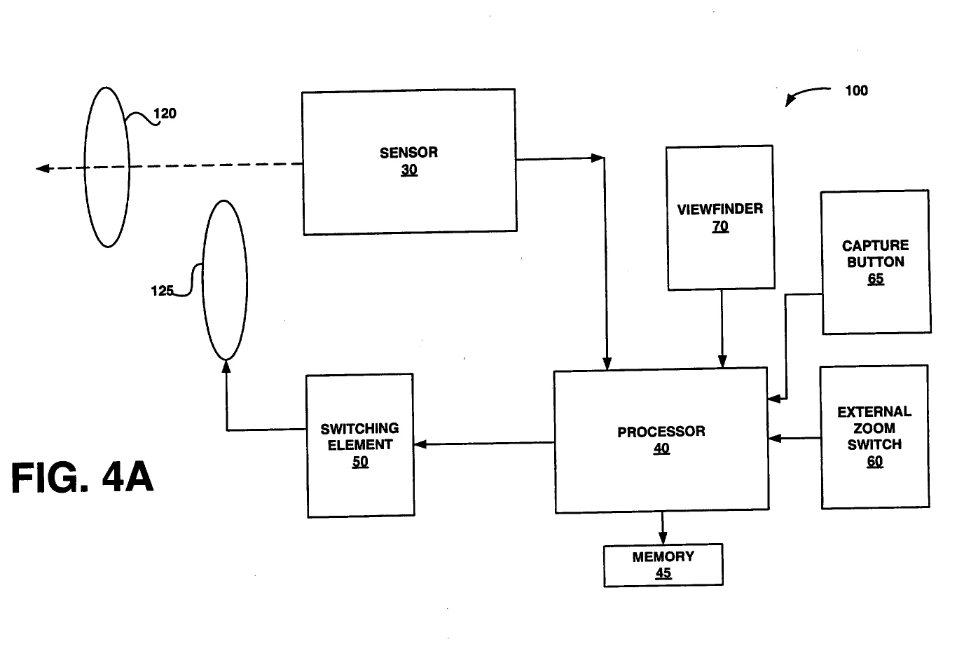

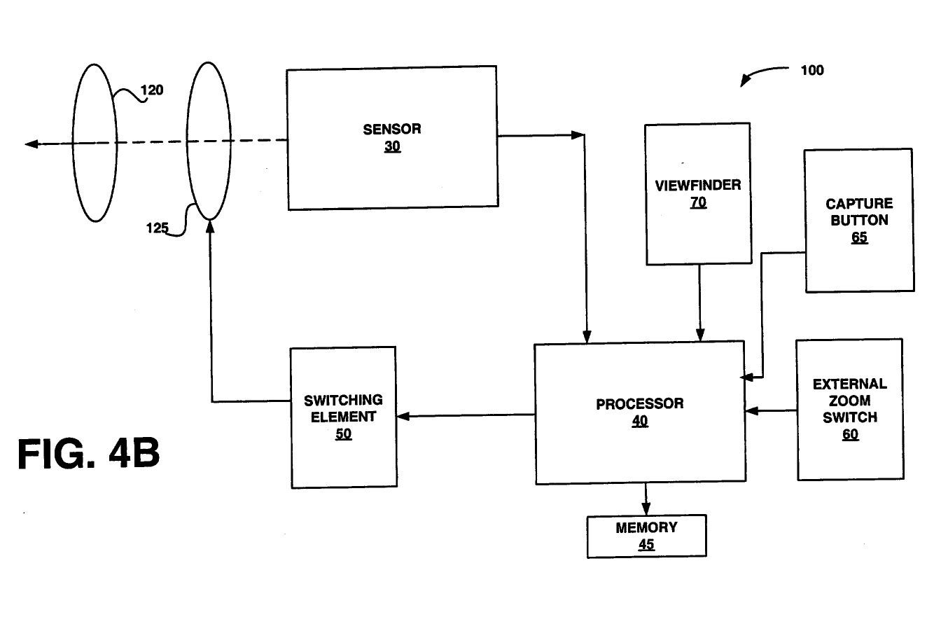

Referring now to FIGS. 4A-4B, there is shown another particular embodiment of the present invention, which is similar to the embodiment shown in FIGS. 1A and 1B. In the system 100 of FIGS. 4A-4B, instead of replacing one lens 120 with another 125, for normal mode, a second lens 125 is centered onto the optical axis A to create a combined lens group having an optical focal length in the normal to telephoto range.

Additionally, the above invention applies to both auto focus and fixed focus cameras. For example, in a 1.3 mega pixel digital image capture device of the present invention having a 28-84 mm 3× effective zoom, fixed focus is feasible. For greater numbers of mega pixels, it may be desirable to use an image capture device having auto focus capabilities.

Note that although at times the use of a single lens has been described in connection with a first lens or a second lens. This is not meant to be limiting, as it is understood that the first and second lenses can comprise additional lenses to complete the referenced lens. For example, the term “lens” should herein be interchangeable with the term “lens group”.

While the invention has been described with reference to a preferred embodiment, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An image capture system, comprising:
an image sensor for producing an output signal representative of a scene to be captured, wherein an optical axis is defined through said image sensor;
a zoom switch, actuation of which produces a zoom signal representative of an instruction to zoom in or zoom out on said scene to be captured;
a first lens initially disposed on said optical axis, said first lens having a preset true focal length;
a second lens initially disposed off said optical axis;
a processor programmed to process said output signal and, in response to said zoom signal, to digitally zoom said output signal to change the effective focal length of whichever of said first and second lenses is located on said optical axis;
wherein said processor is additionally programmed to generate a switching signal once said effective focal length has reached a predetermined effective focal length; and
a switching mechanism for switching said second lens onto said optical axis in response to said switching signal from said processor.

2. The image capture system of claim 1, wherein said processor will further digitally zoom said output signal after generating said switching signal in response to further actuation of said zoom switch.

3. The image capture system of claim 2, wherein said first lens and said second lens are both located on said optical axis after said switching signal is generated.

4. The image capture system of claim 2, wherein said switching mechanism removes said first lens from said optical axis when said switching mechanism switches said second lens onto said optical axis.

5. The image capture system of claim 2, wherein said processor digitally zooms said output signal continuously.

6. The image capture system of claim 2, wherein said processor digitally zooms said output signal in a plurality of steps.

7. The image capture device of claim 6, wherein said image capture device further includes nonvolatile memory and a capture button, and wherein said processed and digitally zoomed output signal is stored in said nonvolatile memory in response to actuation of said capture button.

8. The image capture system of claim 6, further comprising an image display, wherein said processor provides said processed and digitally zoomed output signal at each of said plurality of steps.

9. The image capture system of claim 8, wherein said processed and digitally zoomed output signal for each step is displayed until said processor displays said processed and digitally zoomed output signal for the next step, based on actuation of said zoom switch.

10. The image capture system of claim 9, wherein said switching mechanism removes said first lens from said optical axis when said switching mechanism switches said second lens onto said optical axis.

11. A method of zooming an image capture device, comprising the steps of:
(a) providing an image capture system including:
an image sensor for producing an output signal representative of a scene to be captured, wherein an optical axis is defined through said image sensor;
a zoom switch, actuation of which produces a zoom signal representative of an instruction to zoom in or zoom out on said scene to be captured;
a first lens initially disposed on said optical axis;
a second lens initially disposed off said optical axis;
(b) processing and digitally zooming said output signal in response to said zoom signal to change the apparent magnification factor of said output signal;
(c) generating a switching signal after step (b) when said processed and digitally zoomed output signal reaches a predetermined magnification factor;
(d) switching said second lens onto said optical axis in response to said switching signal of step (c); and
(e) returning the digital zoom magnification factor to 1× after step (d).

12. The method of claim 11, wherein the magnification factor of said output signal starts at 1× and said processing step increases said magnification factor continuously until said magnification factor is reached.

13. The method of claim 11, wherein the magnification factor of said output signal starts at 1× and said processing and digitally zooming step increases said magnification factor incrementally in steps until said magnification factor is reached.

14. The method of claim 11, further comprising the step of:
(f) further processing and digitally zooming said output signal in response to said zoom signal after step (e).

15. The method of claim 14, wherein said switching step results in both said first lens and said second lens being located on said optical axis simultaneously.

16. The method of claim 14, wherein said switching step results in said second lens replacing said first lens on said optical axis.

17. An image capture system, comprising:
an image sensor for producing an output signal representative of a scene to be captured, wherein an optical axis is defined through said image sensor;
a zoom switch, actuation of which produces a zoom signal representative of an instruction to zoom in or zoom out on said scene to be captured;
a first lens initially disposed on said optical axis;
a second lens initially disposed off said optical axis;
a processor programmed to process said output signal and, in response to said zoom signal, to digitally zoom said output signal to change the apparent magnification of said output signal;
wherein said processor is additionally programmed to generate a switching signal once the digitally zoomed magnification factor has reached a predetermined magnification factor; and
a switching mechanism to switch said second lens onto said optical axis in response to said switching signal from said processor
wherein said processor is programmed to return the magnification factor of said output signal to 1× once said second lens is switched onto said optical axis.

18. The apparatus of claim 17, wherein the magnification factor of said output signal starts at 1× and said processor digitally zooms said output signal to increase said magnification factor incrementally in steps in response to said zoom signal.

19. The apparatus of claim 18, wherein said processor is further programmed to increase said magnification factor incrementally in steps in response to said zoom signal after said second lens has been switched onto said optical axis.

20. The method of claim 19, wherein said switching mechanism replaces said first lens with said second lens on said optical axis.
